(19) United States
(12) Patent Application Publication
(10) Pub. No.: US 2008/0083105 A1
(43) Pub. Date: Apr. 10, 2008

(54) Jigs for Producing Joints for Wooden Beams

(76) Inventor: Patrick Burli, Mezieres (CH)

Correspondence Address: PEARNE & GORDON LLP, 1801 EAST 9TH STREET, SUITE 1200, CLEVELAND, OH, 44114-3108, US

(21) Appl. No.: 11/577,545

(22) PCT Filed: Jul. 13, 2005
(86) PCT No.: PCT/CH05/00400

§ 371 Date: Apr. 19, 2007

(30) Foreign Application Priority Data
Nov. 18, 2004 (CH) 1904/04

(51) Int. Cl. B23P 19/04

(52) U.S. Cl. 29/238

(57) ABSTRACT

The invention relates to an assembly comprising two jigs which can be used to produce a dovetail mortise and tenon in order to assemble members of a frame.

The content of Application No PCT/CH2005/000400, filed Jul. 13, 2005 in Switzerland is incorporated here by reference.

This present invention concerns a device or arrangement, an assembly or a kit, that includes jigs employed for the execution of dovetail mortise and tenon joints, intended for assembling the parts of timber beams.

In the area of roof timbers, the assemblies usually employed consist of straight mortise and tenon joints. The implementation of a straight tenon joint is problematic in that it is necessary to use either a high-cost, stationary roof-timber tenoning machine, or a portable circular saw necessitating several manual operations and where the final result lacks precision. Straight mortise and tenon elements executed on roof timber components are slotted into each other by presenting the end of the roof-timber component equipped with the straight tenon against the face of the other part equipped with the mortise, in the same plane. This slotting together necessitates the separation of the two roof timber components, by at least the value of the length of the straight tenon, so that the latter can slot into the mortise. Moreover, a straight tenon is able to pull out of the mortise if the assembly is not pinned or held by some other technical means. By definition, a straight mortise and tenon joint is not self-tightening.

Another assembly technique used in the area of roof timbers consists of a dovetail-shaped mortise and tenon, slotting into each other in a self-tightening manner and whose implementation up to the present has been exclusively made possible by a numerical-control machine for the execution of roof timbers and whose cost is extremely high. Such a machine is intended to produce roof-beam assemblies that are prefabricated in the factory. Because of its dimensions, it is not intended to operate on a building site.

Another common way to create roof-timber assemblies involves the use of metal connectors fitted to and hammered into the roof timber components. The majority of the metal connectors include a male part and a female part which are intended to slot into each other. These connectors are positioned and fixes on the roof timber components by means of anchoring screws or nails with or without prior milling of a recess. The connectors and the hardware necessary for their attachment represent expensive equipment whose acquisition is required every time it is necessary to construct an assembly. The execution of such assemblies necessitates many operations and is therefore relatively lengthy.

Regarding the existing portable jigs employed in the roofing area, these are intended for many applications such as milling for the accommodation of metal fittings, the positioning of metal fittings or as a drilling guide. The existing jigs do not allow the milling of dovetail mortises and tenons for roof timbers in a manner that is portable.

One aim of the invention is therefore to propose a device used to make-up assemblies of roof timber components that do not have the drawbacks of the known devices. In particular the device must be portable, must allow the execution of assemblies by dovetail mortise and tenon joints that are easy to execute equally well on a building site or in a workshop, and which can be executed in a repetitive manner, with the equipment required being relatively inexpensive.

To this end, a device, an assembly or a kit is proposed that includes in particular a male jig for assembly of the tenons and a female jig for assembly of the mortises, as described in claim 1. Particular methods of implementation and variants are described in dependent claims.

The invention is described in detail below, this description being given with reference to the attached appendix of drawings, in which:

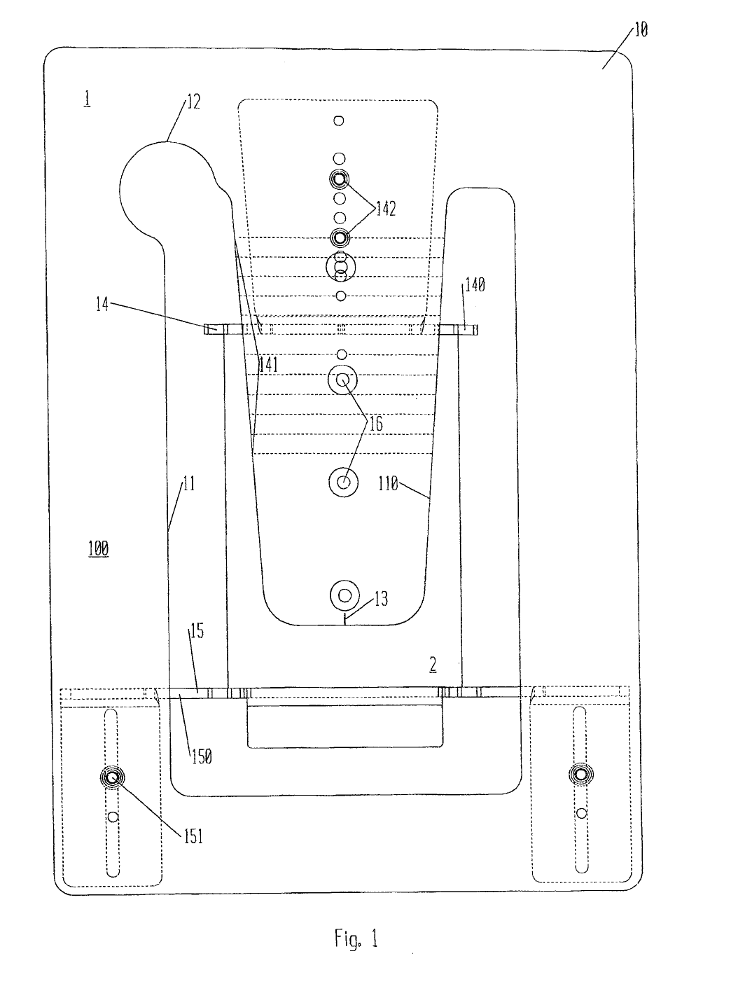

FIG. 1 is a front view of one preferential form of execution of a male jig,

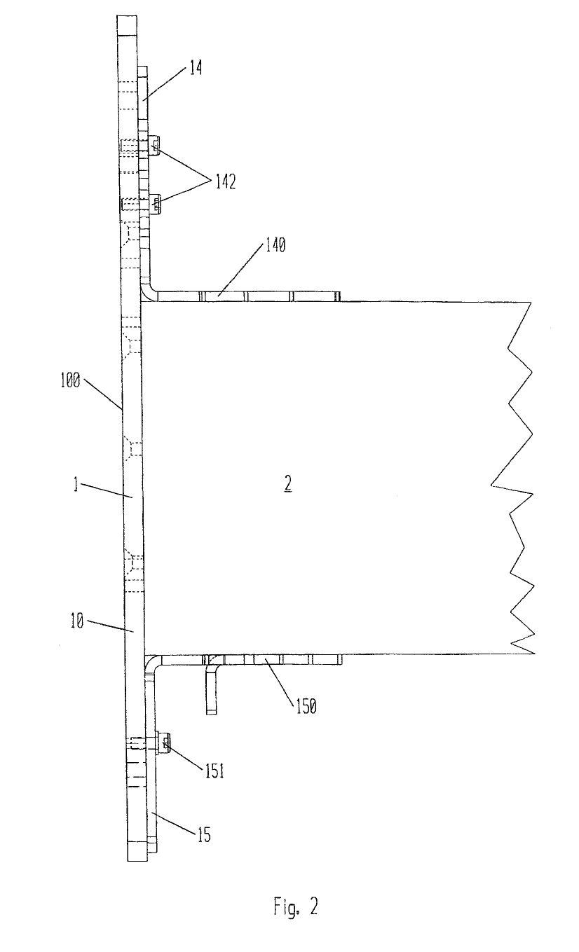

FIG. 2 is a side view of the male jig of the preceding figure,

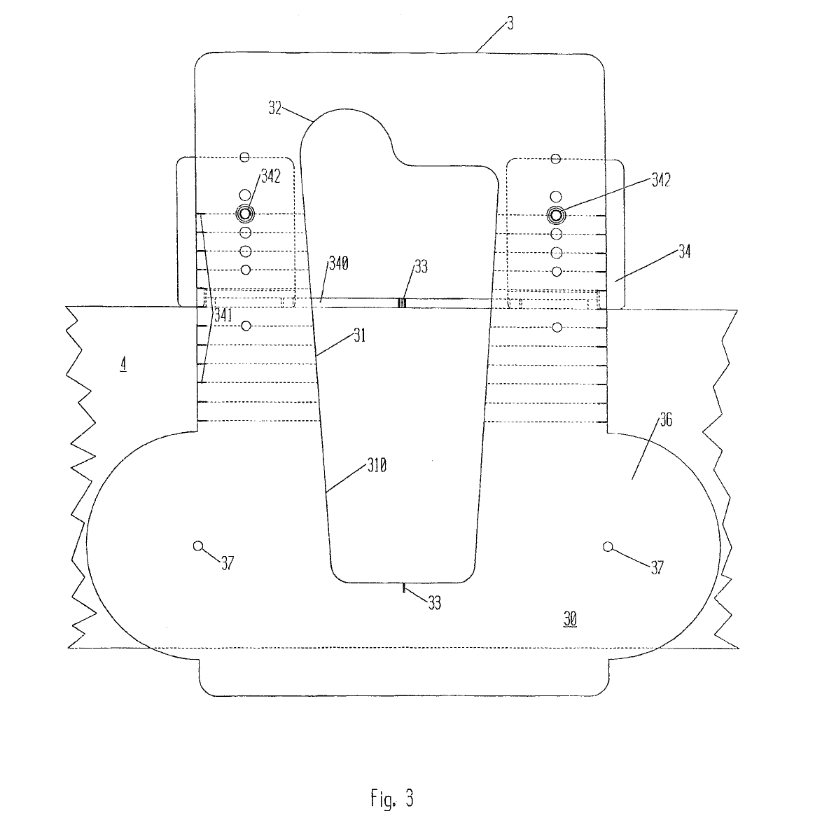

FIG. 3 is a front view of a preferential form of execution of a female jig, and

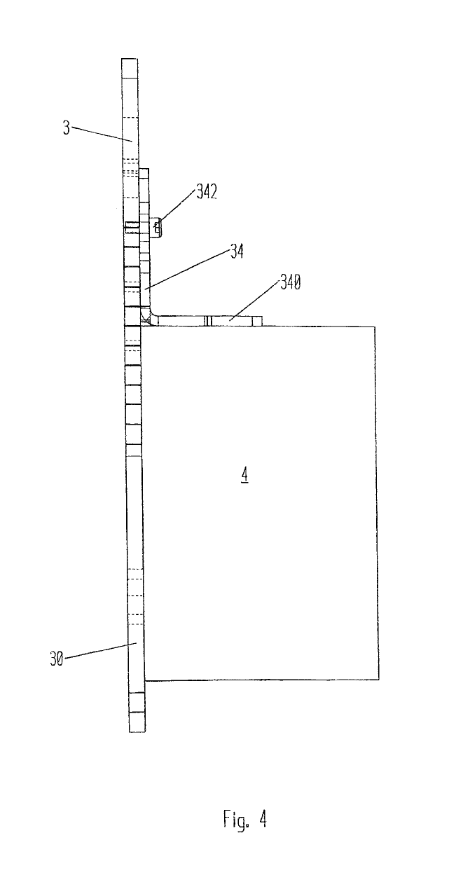

FIG. 4 is a side view of the female jig of the preceding figure.

The male jig 1 shown in FIGS. 1 and 2 is intended to be used for the execution of a dovetail-shaped tenon on an end face of a timber beam 2, seen here behind the jig. The jig 1 is composed essentially of a rigid plate 10, preferably in metal or a hard synthetic material. The plate 10 includes a cut-out 11 of which a central part 110 is of dovetail shape. The cut-out 11 also includes an indentation 12, outside of the part 110 in dovetail form, intended to position a router at the start of milling the tenon. The jig 1 also has an adjustable end-stop 14, placed behind the plate 10, and which includes a bearing part 140 that is intended to press against the upper surface of the beam 2. Given that the height of the tenon is generally a function of the height of the beam, then since the height of the tenon is generally about ⅔rds the height of the bearer beam on which the mortise will be executed, the position of the end-stop 14 and of the bearing part 140 respectively on the jig 1 is adjustable along location resources, such as markers 141 indicating different heights of the beam or of the tenons for example, the end-stop 14 then being fixed at the chosen height by fixing resources, such as one or more screws 142 for example. The jig also includes a clamping end-stop 15, also positioned behind the plate 10, and which includes a gripping part 150 intended to clamp down on the face of the beam 2 opposite to that on which the bearing part 140 is located. Fixing resources 151, such as screws for example, are used to fix the clamping end-stop 15, so that the beam 2 is gripped between the bearing parts 140 and 150. The bearing parts 140 and 150 can include teeth or claws, not shown in the figures, intended penetrate into the beam, or any other slip-prevention resource, that helps to hold the jig 1 more firmly on the end of the beam 2. The jig 1 can also include centring resources, such as a marker 13 for example created here on a central part of the cut-out, or any other marker resource, such as a stepped cut-out for example, created on the adjustable end-stop 14 and/or on the clamping end-stop 15 used to position the jig 1 on the beam 2, in order that the tenon is shaped to the centre of the face at end of the beam 2.

After having fitted, positioned and fixed the jig 1 on the end of the beam 2, the clamping of the bearing parts 140 and 150 can be further improved by placing one or two joint-clamps on these bearing parts 140 and 150. In order to leave clear the passage of the milling head during the milling of the tenon, the bearing parts 140 and 150 each includes an indentation close to the central part of the dovetail-shaped cut-out 11. Holes 16 created in the central part of the jig 1, can be used to screw the jig 1 onto the end of the beam 2, in the event that, depending on the configuration or the shape of the beam 2, it is not possible to fix the jig by the means described above.

The female jig 3, illustrated in FIGS. 3 and 4, is intended to be used for the execution of a dovetail-shaped mortise on one face of a timber beam 4. The jig 3 is composed essentially of a rigid plate 30, preferably in metal or a hard synthetic material, and preferably slightly thinner than the plate 10 of jig 1, for a reason that will be explained later. The plate 30 includes a cut-out 31, of which a central part 310 is of dovetail shape, similar to the dovetail shape of the cut-out 110 of jig 1. An indentation 32 is created on the cut-out 31, outside of the dovetail-shaped zone, to allow the positioning of a router at the start of milling the mortise. The jig 3 also has an adjustable end-stop 34, placed behind the plate 30 and that includes a bearing part 340 intended to press against on the upper surface of the beam 4. As before, the position of the end-stop 34 and of the bearing part 340 respectively is adjustable along location resources, such as markers 341 for example, indicating different heights of the beam or the tenons, with the end-stop 34 then being fixed according to the height set by the fixing resources, such as one or more screws 342 for example. The jig 3 can also include a clamping end-stop (not shown in the figure), that includes a gripping part and fixing resources, and functioning like the corresponding clamping end-stop described for the male jig. Given that sometimes the beam 4 in which one or more mortises are to be created is positioned at the top of a wall, its lower face, which should be gripped by the clamping end-stop, is not accessible. Other fixing resources must therefore also be provided, like parts in the form of lugs 36 on the metal plate for example, intended to receive joint-clamps for gripping the beam, or holes 37 used to screw the jig 3 onto the beam 4, in order secure it there. The choice of the appropriate fixing resource will depend upon the configuration and the shape of the beam 4 or the characteristics of a job in a workshop or on a building site. As before, in order to leave clear the passage of the milling machine during the execution of the mortise, the bearing part 340 and any bearing part of the clamping resource each includes an indentation close to the central part of the dovetail-shaped cut-out 31. A marker resource 33, such as a notch on a central part of the cut-out 31 for example, or another marker resource on the adjustable end-stop 34, is used to position the jig 3 accurately on the beam 4.

For the execution of a tenon on the end of a beam, one takes a male jig 1 and determines to begin with the position setting for the adjustable end-stop 14, according to the dimensions of the bearer beam, and then this end stop is fixed in position on the jig using the fixing resources 142. Then the jig 1 is placed on the end face of the beam 2, with the bearing part 140 being placed on the upper surface of the beam, the jig is centred by a suitable centring resource, and the jig 1 is fixed onto the end of the beam using either the fixing resources described. A manual router of the conventional type is then prepared, by equipping it with a copying ring and a dovetail-shaped milling head. In the event that the dimensions of the support table incorporated into the router is not adequate to provide suitable support for the latter on the surface of the jig, an extension of this support table can be included. The milling height, namely the distance between the end of the milling machine and the support table is set using an adjusting gauge or any other measuring resource so as to correspond to the depth of the tenon and the mortise respectively. The router is then inserted into the indentation 12, bearing firstly through its support table onto the surface of the jig and secondly through its copying ring against the part dovetail-shaped cut-out 110. The router is switched on and the milling operation is executed by following the cut-out 110, and then where necessary by milling the remainder of the beam outside of the field of action of the milling machine when the copying ring remains in contact with the cut-out 110. After removing the router and the jig from the end of the beam, a beam 2 equipped with a tenon of a depth determined and perfectly shaped at its end, is the result.

The execution of a mortise on a beam 4 is performed in a relatively similar manner. One starts with a female jig 3 and sets the position of the adjustable end-stop 34 to the same value as the adjustment setting used on jig 1, and then the jig 3 is positioned and fixed on the beam 4 at the position where the mortise is to be created. Without altering the depth setting of the milling head on the router, the mortise is milled in a similar manner to that described above. After removal of the router and the jig, a beam 4 equipped with a mortise of a determined depth and perfectly formed, is the result.

It has been stated previously that the thickness of the plate 30 forming the female jig 3 is slightly less than that of the plate 10 forming the male jig 1. By keeping constant the depth setting of the milling head on the router, a mortise is therefore obtained that is slightly deeper than the tenon, which, as a result of the play thus created, allows easy assembly of these two elements and a perfect levelling of the assembly on the visible parts of the beams.

Preferably several kits, assemblies or sets of male and female jigs should be made available, with these different kits, assemblies or sets, each corresponding to beams within a certain range of dimensions. One will this have, for example, one set of male and female jigs for of the beams of small dimensions, for the assembly of narrow dovetail joints, another set for beams of medium dimensions for the assembly of dovetail joints of average dimensions, and a last set for beams of large dimension, for the assembly of dovetail joints of large dimensions. Thus the mortises and tenons are still dimensioned so as to have the maximum possible load potential to suit the dimensions of the beams to be assembled.

Thus by means of the device described, which includes the sets of jigs described, it is now possible to execute dovetail mortise and tenon joints on beams which are self-tightening, either in a workshop or directly on the building site, repeatedly and in a simple manner that is inexpensive.

1. A kit for the assembly of sets of parts of a timber beam, comprising:
at least one first male jig that includes a rigid plate intended to be placed on an end face of a timber beam for the execution of a tenon on the said end face of the beam, and
at least one second female jig that includes a rigid plate intended to be placed on part of the face of a timber beam for the execution of a mortise on the said part of the face of the beam,
where the said jigs are designed to execute a dovetail-shaped mortise or tenon respectively.

2. A kit according to claim 1, wherein the first male jig includes a bearing surface and a cut-out of which a central part is of dovetail shape, the said bearing surface and the said dovetail-shaped cut-out being intended to fit together, for the execution of the said tenon with a router that is equipped in particular with a support table resting on the bearing surface with a copying ring resting on the dovetail-shaped cut-out and with a milling head for execution of the said dovetail-shaped tenon, where the said tenon has a given depth.

3. A kit according to claim 1, wherein the second female jig includes a bearing surface and a cut-out of which a central part is of dovetail shape, with the said bearing surface and the said dovetail-shaped cut-out being intended to fit together, for the execution of the said tenon, with a router that is equipped in particular with a support table resting on the bearing surface with a copying ring resting on the dovetail-shaped cut-out, and with a milling head for execution of the said dovetail-shaped mortise, where the said mortise has a given depth.

4. A kit according to claim 1, wherein the thickness of the rigid plate of the first male jig is greater than the thickness of the rigid plate of the second female jig.

5. A kit according to claim 2, wherein the cut-out of each jig includes an indentation placed outside of the dovetail-shaped cut-out part, intended to position the router at the start of the operation.

6. A kit according to claim 1, wherein each jig includes a centering resource used to position the said jig on the beam to be shaped.

7. A kit according to claim 1, wherein each jig includes an adjustable end-stop resource used to position the said jig on the beam to be shaped.

8. A kit according to claim 7, wherein each jig includes a marking resource used to adjust the position of the said adjustable end-stop resource according to the size of the bearer beam or according to the size of the tenon or the mortise to be executed.

9. A kit according to claim 1, wherein each jig includes at least one fixing resource used to fix the said jig onto the beam.

10. A kit according to claim 1, including several sets of male and female jigs, each set being designed for a beam in a given dimensional range.

11. The use of a kit according to claim 1, for the assembly of timber beams by mortise and tenon joints.

12. The use of a kit according to claim 11, during which no variation of the depth setting of the milling head on the router will be performed between the execution of a mortise and that of a corresponding tenon.
